(19) United States
(12) Patent Application Publication
(10) Pub. No.: US 2025/0061170 A1
(43) Pub. Date: Feb. 20, 2025

(54) COMPUTER-READABLE RECORDING MEDIUM STORING QUESTIONNAIRE DATA ANALYSIS PROGRAM, QUESTIONNAIRE DATA ANALYSIS METHOD, AND INFORMATION PROCESSING APPARATUS

(71) Applicant: Fujitsu Limited, Kawasaki-shi (JP)

(72) Inventor: Kazuhiro MATSUMOTO, Kawasaki (JP)

(73) Assignee: Fujitsu Limited, Kawasaki-shi (JP)

(21) Appl. No.: 18/787,013

(22) Filed: Jul. 29, 2024

(30) Foreign Application Priority Data
Aug. 16, 2023 (JP) 2023-132474

(51) Int. Cl. G06F 18/211

(52) U.S. Cl. CPC G06F 18/211

(57) ABSTRACT

A recording medium stores a program for causing a computer to execute processing including: generating rules that indicates an answer pattern to questions included in questions, based on questionnaire data that indicates answers of respondents to each of the questions in a conducted questionnaire survey; specifying a respondent who has provided a correct answer that is same as an answer pattern to a question indicated in a rule, for each of the rules, based on the questionnaire data; and determining a first rule selection pattern, based on the number of questions included in selected rules, from among rule selection patterns that satisfy a first constraint condition that each of the respondents is specified as the respondent who has provided the correct answer by any one of the single or the selected rules, among rule selection patterns generated by selecting the single or the rules from among the rules.

### CROSS-REFERENCE TO RELATED APPLICATION

This application is based upon and claims the benefit of priority of the prior Japanese Patent Application No. 2023-132474, filed on Aug. 16, 2023, the entire contents of which are incorporated herein by reference.

### FIELD

The embodiments discussed herein are related to a questionnaire data analysis program, a questionnaire data analysis method, and an information processing apparatus.

### BACKGROUND

In order to recognize a general tendency of behaviors of people having various attributes, questionnaire surveys and data analysis using answers of questionnaire respondents to questions are widely conducted. For example, a large number of people are asked to answer a questionnaire regarding an attribute and a food waste behavior tendency of the person, and data analysis is performed on the answer result using a computer. As a result, it is possible to find a causal relationship regarding what kind of food waste behavior respondents having what kind of attribute have. In order to appropriately analyze the questionnaire, it is important that a question in the questionnaire is appropriate.

Japanese Laid-open Patent Publication No. 2012-079297, International Publication Pamphlet No. WO 2022/124107, U.S. Patent Application Publication No. 2017/0046801, U.S. Patent Application Publication No. 2018/0060735, and International Publication Pamphlet No. WO 2018/105656 are disclosed as related art.

### SUMMARY

According to an aspect of the embodiments, a non-transitory computer-readable recording medium stores a questionnaire data analysis program for causing a computer to execute processing including: generating a plurality of rules that indicates an answer pattern to two or more questions included in a plurality of questions, based on questionnaire data that indicates answers of a plurality of respondents to each of the plurality of questions in a conducted questionnaire survey; specifying a respondent who has provided a correct answer that is same as an answer pattern to a question indicated in a rule, for each of the plurality of rules, based on the questionnaire data; and determining a first rule selection pattern, based on the number of questions included in a single or a plurality of selected rules, from among rule selection patterns that satisfy a first constraint condition that each of the plurality of respondents is specified as the respondent who has provided the correct answer by any one of the single or the plurality of selected rules, among a plurality of rule selection patterns generated by selecting the single or the plurality of rules from among the plurality of rules.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a questionnaire data analysis method according to a first embodiment;

FIG. 2 is a diagram illustrating an example of hardware of a computer;

FIG. 3 is a diagram illustrating an example of quality evaluation of a questionnaire survey by cluster analysis;

FIG. 4 is a block diagram illustrating functions of a computer for analyzing a question that can be deleted from the questionnaire survey;

FIG. 5 is a diagram illustrating an example of questionnaire data;

FIG. 6 is a flowchart illustrating an example of a procedure of a process for analyzing a question that can be deleted;

FIG. 7 is a diagram illustrating an example of a rule candidate creation process;

FIG. 8 is a diagram illustrating an example of rule candidate information;

FIG. 9 is a flowchart illustrating an example of a procedure of the rule candidate creation process;

FIG. 10 is a diagram illustrating an example of a relationship between the number of rules and the number of wrong answers;

FIG. 11 is a flowchart illustrating an example of a procedure of a use rule determination process;

FIG. 12 is a diagram illustrating an example of constants and arrays to be set;

FIG. 13 is a diagram illustrating an example of a method for calculating a minimum number of the number of rules;

FIG. 14 is a diagram illustrating an example of a method for calculating a minimum number of the number of wrong answers;

FIG. 15 is a diagram illustrating an example of a method for calculating a maximum number of the number of rules;

FIG. 16 is a diagram illustrating an example of a method for calculating a maximum number of the number of wrong answers;

FIG. 17 is a diagram illustrating an example of an operation reception of a user;

FIG. 18 is a diagram illustrating an example of a method for calculating a minimum number of questions;

FIG. 19 is a flowchart illustrating an example of a procedure of a usefulness calculation process;

FIG. 20 is a diagram illustrating an example of an analysis result regarding a rule to be used; and

FIG. 21 is a diagram illustrating an example of an analysis result regarding usefulness of the question.

### DESCRIPTION OF EMBODIMENTS

As a technique regarding the data analysis, for example, a question item selection method for questionnaire data analysis has been proposed that enables to use questionnaire data by questionnaires conducted for the same survey purpose at different times and places as questionnaire data to evaluate the same characteristics. A model construction device has been also proposed that evaluates reliability of answer content of a respondent to an electronic questionnaire with higher accuracy than before. A management method has been also proposed that determines a size of a food part of a user, by using a machine learning model. A system has been proposed that predicts a personality attribute, including analyzing a set of data and matching the set of the data with a set of operator's personality attributes. Moreover, for various applications, a device has been proposed that includes an inference engine that can infer using a rule set as small as possible.

In a questionnaire survey, if the number of questions is too large, a burden of a respondent increases. If the burden of the respondent is too large, it is difficult to secure a sufficient amount of respondents. For example, even if the respondent starts to input an answer to the questionnaire survey, there is a possibility that the respondent is fed up with the number of questions and stops the answer input in the middle. Therefore, it is requested to reduce the number of questions.

However, if the number of questions is excessively reduced, quality of an analysis result when a questionnaire survey result is analyzed is impaired. Typically, there is no index used to determine how many questions can be reduced without impairing the quality of the analysis result. Therefore, it is not possible to carelessly reduce the questions, and it is difficult to reduce the number of questions.

In one aspect, this case enables to easily determine a question that can be deleted from a questionnaire survey.

Hereinafter, the present embodiment will be described with reference to the drawings. Note that each of the embodiments can be implemented in combination with the plurality of embodiments as long as no contradiction arises.

### First Embodiment

A first embodiment is a questionnaire data analysis method that enables to easily determine a question that may be deleted, from among questions used in a questionnaire survey, based on the questionnaire survey conducted in the past.

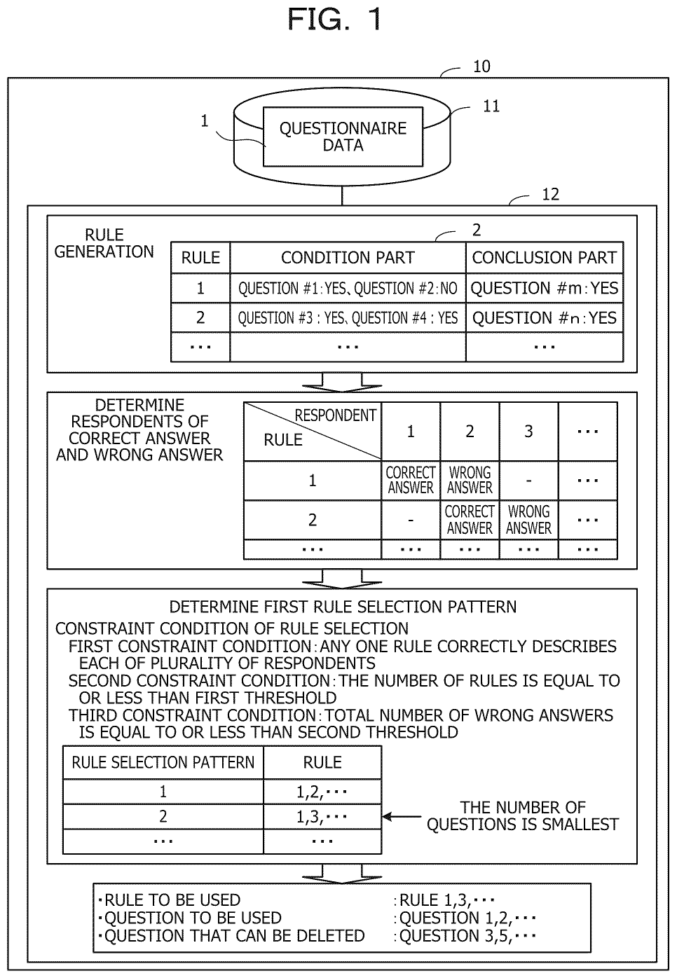

FIG. 1 is a diagram illustrating an example of the questionnaire data analysis method according to the first embodiment. In FIG. 1, an information processing apparatus 10 that executes the questionnaire data analysis method is illustrated. The information processing apparatus 10 can execute the questionnaire data analysis method, for example, by executing a questionnaire data analysis program.

The information processing apparatus 10 includes a storage unit 11 and a processing unit 12. The storage unit 11 is, for example, a memory or a storage device included in the information processing apparatus 10. The processing unit 12 is, for example, a processor or an arithmetic circuit included in the information processing apparatus 10.

The storage unit 11 stores questionnaire data 1 indicating answers of a plurality of respondents to each of a plurality of questions in the questionnaire survey conducted in the past. The processing unit 12 determines a question that is desirable to be used in questionnaire surveys in the future and a question that may be deleted, based on the questionnaire data 1.

First, the processing unit 12 generates a plurality of rules indicating an answer pattern for a combination of two or more questions, based on the questionnaire data 1. The processing unit 12 generates, for example, rule information 2 indicating a plurality of rules. The generated rule includes, for example, a condition part and a conclusion part. In each of the condition part and the conclusion part, the answer pattern for each of one or more questions is set.

A respondent who has provided an answer same as the answer pattern set to the rule, to the question in each of the condition part and the conclusion part of the rule is a respondent who has correctly answered. The respondent who has provided a correct answer for the rule can be also referred to as a respondent correctly described by the rule.

A respondent who has provided an answer same as the answer pattern (first answer pattern) set to the rule, to the question in the condition part of the rule and has provided an answer different from the answer pattern (second answer pattern) set to the rule, to the question in the conclusion part is a respondent who has provided a wrong answer. The respondent who has provided a wrong answer for the rule can be also referred to as a respondent erroneously described by the rule.

A respondent who has provided an answer different from the first answer pattern, to the question in the condition part of the rule is a respondent to whom the rule is not applied.

After generating the rule, the processing unit 12 specifies a respondent who has provided the answer same as the answer pattern to the question indicated in the rule, for each of the plurality of rules, based on the questionnaire data 1. In the example in FIG. 1, a first rule is that a first respondent is a respondent who has provided a correct answer, a second respondent is a respondent who has provided a wrong answer, and a third respondent is a respondent to whom the rule is not applied. Furthermore, a second rule is that the first respondent is a respondent to whom the rule is not applied, the second respondent is a respondent who has provided a correct answer, and the third respondent is a respondent who has provided a wrong answer.

Then, the processing unit 12 determines a first rule selection pattern, based on the number of questions included in one or a plurality of selected rules, from among a plurality of rule selection patterns that is generated by selecting one or a plurality of rules from among the plurality of rules and satisfies a first constraint condition. The first constraint condition is a condition that each of the plurality of respondents is specified as a respondent who has provided a correct answer, according to any one of one or the plurality of selected rules.

For example, the processing unit 12 determines a rule selection pattern in which the number of questions included in the one or the plurality of selected rules is minimized, as the first rule selection pattern. The rule selection pattern that satisfies the constraint condition and minimizes the number of included questions can be specified, for example, using a solution searching method for a combination optimization problem.

The processing unit 12 outputs the determined first rule selection pattern, for example, as a rule to be used in the questionnaire survey in the future. Furthermore, the processing unit 12 may output a question included in any one of the rules selected in the first rule selection pattern as a question to be used in the questionnaire survey in the future. Moreover, the processing unit 12 may output a question that is not included in any one of the rules selected in the first rule selection pattern, from among the plurality of questions indicated in the questionnaire data 1, as the question that can be deleted from the questionnaire survey.

In this way, it is possible to easily determine the question that can be deleted, from among the questions used in the questionnaire survey in the past. If the number of questions used in the questionnaire survey can be reduced, a burden of the respondent who answers the questionnaire survey is reduced, and this makes it easier to obtain answers from many people.

Note that the processing unit 12 can include a condition other than the first constraint condition, as the constraint condition imposed on the plurality of rule selection patterns. For example, the processing unit 12 determines the first rule selection pattern, from among rule selection patterns that satisfy a second constraint condition that the number of selected rules is equal to or less than a first threshold, in addition to the first constraint condition.

If the number of rules is too large, a difference in features of the respondents corresponding to different rules becomes small. Then, features of a respondent corresponding to a certain rule become unclear. By limiting the number of rules to be equal to or less than the first threshold, an excessive increase in the number of rules is suppressed, and the combination of the rules that can explain the features of the respondent in a clarifying manner is determined as the first rule selection pattern.

Note that, if the first threshold regarding the number of rules is too small, there is a possibility that the first constraint condition cannot be satisfied. Therefore, the processing unit 12 allows the first threshold within a range in which the first constraint condition can be satisfied. For example, the processing unit 12 specifies a second rule selection pattern in which the number of selected rules is the smallest, from among the plurality of rule selection patterns that satisfies the first constraint condition. Then, the processing unit 12 sets the number of rules in the second rule selection pattern as a lower limit of the number of rules and sets a value equal to or more than the lower limit as the first threshold. As a result, a situation is prevented in which there is no rule selection pattern that satisfies both of the first constraint condition and the second constraint condition and it is not possible to determine the first rule selection pattern.

The processing unit 12 can set a constraint condition regarding a total number of wrong answers, as the constraint condition. For example, an answer pattern to the question in the condition part of the plurality of generated rules is set as a first answer pattern, and an answer pattern to the question in the conclusion part is set as a second answer pattern. The processing unit 12 specifies a respondent who provides the same answer as the first answer pattern for the question in the condition part and provides a wrong answer that is an answer different from the second answer pattern for the question in the conclusion part, for each of the plurality of rules, based on the questionnaire data 1. Then, the processing unit 12 determines the first rule selection pattern, from among rule selection patterns that satisfy a third constraint condition that the total number of respondents who have provided a wrong answer for each selected rule is equal to or less than a second threshold, in addition to the first constraint condition.

As a result, an incorrect rule is prevented to be used. For example, a large number of respondents who have provided the wrong answer means that accuracy of the rule (whether or not respondent is correctly described) is insufficient. An excessive increase in the number of respondents who have provided the wrong answer is prevented by the second threshold, and accuracy equal to or more than a predetermined value is secured.

Note that, if the second threshold regarding the total number of respondents who have provided the wrong answer is too small, there is a possibility that the first constraint condition cannot be satisfied. Therefore, the processing unit 12 allows the second threshold within a range in which the first constraint condition can be satisfied. For example, the processing unit 12 specifies a third rule selection pattern in which the total number of respondents who have provided the wrong answer for each of the selected rules is the smallest, from among the rule selection patterns that satisfy the first constraint condition. Then, the processing unit 12 sets the total number of respondents who have provided the wrong answer for each rule in the third rule selection pattern as a lower limit of the total number of respondents who have provided the wrong answer and sets a value equal to or more than the lower limit as the second threshold. As a result, a situation is prevented in which there is no rule selection pattern that satisfies both of the first constraint condition and the third constraint condition and it is not possible to determine the first rule selection pattern.

In a case where both of the first threshold and the second threshold are used, an upper limit of the second threshold of the total number of respondents who have provided the wrong answer is determined, based on the lower limit of the first threshold of the number of rules. Furthermore, an upper limit of the first threshold of the number of rules is determined, based on the lower limit of the second threshold of the total number of respondents who have provided the wrong answer. Therefore, the processing unit 12 sets each of the first threshold and the second threshold to values between the lower limit and the upper limit.

For example, the processing unit 12 specifies a fourth rule selection pattern in which the number of selected rules is the smallest, from among the rule selection patterns that satisfy the first constraint condition and in which the total number of respondents who have provided the wrong answer for each selected rule is equal to or less than the lower limit of the total number of respondents who have provided the wrong answer.

Furthermore, the processing unit 12 specifies a fifth rule selection pattern in which the total number of respondents who have provided the wrong answer for each selected rule is the smallest, from among the rule selection patterns that satisfy the first constraint condition and in which the number of selected rules is equal to or less than the lower limit of the number of rules.

The processing unit 12 sets a value equal to or more than the number of rules (lower limit) in the second rule selection pattern and equal to or less than the number of rules (upper limit) in the fourth rule selection pattern, as the first threshold. Moreover, the processing unit 12 sets a value equal to or more than the total number (lower limit) of respondents who have provided the wrong answer for each rule in the third rule selection pattern and equal to or less than the total number (upper limit) of respondents who have provided the wrong answer for each rule in the fifth rule selection pattern, as the second threshold. Then, the processing unit 12 determines the first rule selection pattern, from among the rule selection patterns that satisfy the second constraint condition regarding the number of rules and the third constraint condition regarding the total number of respondents who have provided the wrong answer, in addition to the first constraint condition.

In this way, by determining the upper limit and the lower limit of each of the first threshold and the second threshold, a situation is prevented in which it is not possible to determine the first rule selection pattern due to an error in setting of the first threshold and the second threshold.

The processing unit 12 can more accurately calculate usefulness of each question in the questionnaire survey. For example, the processing unit 12 repeatedly executes the process for determining the first rule selection pattern, while changing a condition required for the plurality of generated rule selection patterns. Then, the processing unit 12 counts the number of times when each of the plurality of questions is used in the rule selected in each first rule selection pattern repeatedly determined. A counting result for each question indicates the usefulness of each question. By quantifying the usefulness for each question in this way, a conductor of the questionnaire can easily determine the question that can be deleted from the questionnaire survey.

Furthermore, the processing unit 12 can limit a rule to be selected when the rule selection pattern is generated, to a rule that can describe a sufficient number of respondents. For example, the processing unit 12 generates a plurality of rules in which the answer pattern to the plurality of questions is divided into the first answer pattern to the question in the condition part and the second answer pattern to the question in the conclusion part. The processing unit 12 calculates the number of condition applicable persons who have provide an answer same as the first answer pattern to the question in the condition part, for each of the plurality of rules, based on the questionnaire data 1. Then, the processing unit 12 deletes a rule of which the number of condition applicable persons is less than a predetermined value, among the plurality of rules, from the selection target in the generation of the plurality of rule selection patterns. As a result, the rule selection pattern is prevented from including a rule with low utility value, and efficiency of the process for determining the first rule selection pattern is improved.

Moreover, the processing unit 12 can limit the rule to be selected when the rule selection pattern is generated to a rule that can describe the respondent with sufficient accuracy. For example, the processing unit 12 generates the plurality of rules in which the answer pattern to the plurality of questions is divided into the first answer pattern to the question in the condition part and the second answer pattern to the question in the conclusion part. The processing unit 12 calculates a ratio of the respondents who have provided the correct answer same as the second answer pattern to the question in the conclusion part, among the number of condition applicable persons who have provided the same answer as the first answer pattern to the question in the condition part, for each of the plurality of rules, based on the questionnaire data 1. Then, the processing unit 12 deletes a rule of which the ratio of the respondents who have provided the correct answer is less than a predetermined value, among the plurality of rules, from the selection target in the generation of the plurality of rule selection patterns. As a result, the rule selection pattern is prevented from including a rule with low accuracy, and the efficiency of the process for determining the first rule selection pattern is improved.

### Second Embodiment

Next, a second embodiment will be described. The second embodiment is a computer that analyzes a question useful for a questionnaire and a question that may be deleted from the questionnaire, using a questionnaire survey result in the past related to food waste.

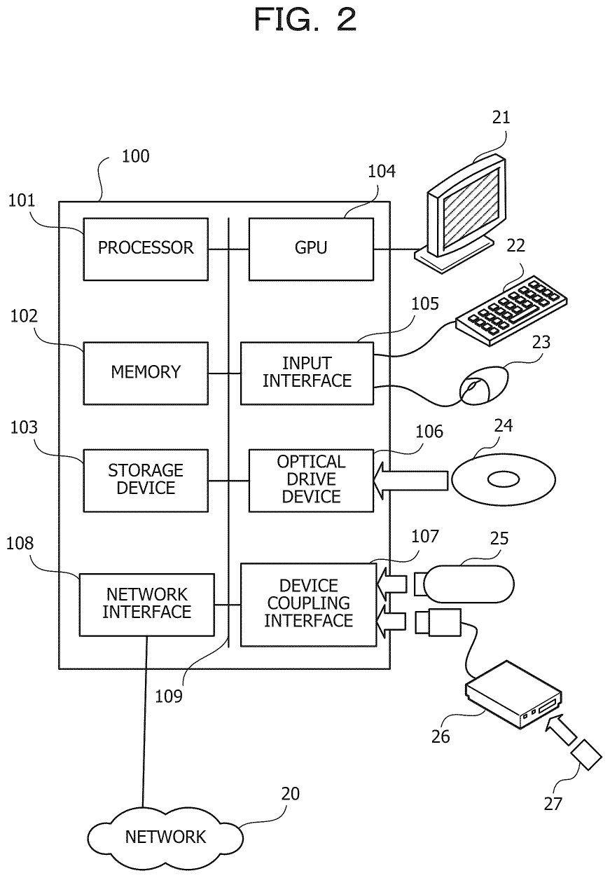

FIG. 2 is a diagram illustrating an example of hardware of the computer. An entire device of a computer 100 is controlled by a processor 101. A memory 102 and a plurality of peripheral devices are coupled to the processor 101 via a bus 109. The processor 101 may be a multiprocessor. The processor 101 is, for example, a central processing unit (CPU), a micro processing unit (MPU), or a digital signal processor (DSP). At least a part of functions implemented by the processor 101 executing a program may be implemented by an electronic circuit such as an application specific integrated circuit (ASIC) or a programmable logic device (PLD).

The memory 102 is used as a main storage device of the computer 100. The memory 102 temporarily stores at least a part of operating system (OS) programs and application programs to be executed by the processor 101. Furthermore, the memory 102 stores various types of data to be used in processing by the processor 101. As the memory 102, for example, a volatile semiconductor storage device such as a random access memory (RAM) is used.

Examples of the peripheral devices coupled to the bus 109 include a storage device 103, a graphics processing unit (GPU) 104, an input interface 105, an optical drive device 106, a device coupling interface 107, and a network interface 108.

The storage device 103 electrically or magnetically performs data writing/reading on a built-in recording medium. The storage device 103 is used as an auxiliary storage device of the computer 100. The storage device 103 stores OS programs, application programs, and various types of data. Note that, as the storage device 103, for example, a hard disk drive (HDD) or a solid state drive (SSD) may be used.

The GPU 104 is an arithmetic device that executes image processing. The GPU 104 is an example of a graphics controller. A monitor 21 is coupled to the GPU 104. The GPU 104 causes a screen of the monitor 21 to display an image according to an instruction from the processor 101. Examples of the monitor 21 include a display device using organic electro luminescence (EL), a liquid crystal display device, and the like.

A keyboard 22 and a mouse 23 are coupled to the input interface 105. The input interface 105 transmits signals sent from the keyboard 22 and the mouse 23 to the processor 101. Note that the mouse 23 is an example of a pointing device, and another pointing device may also be used. Examples of the another pointing device include a touch panel, a tablet, a touch pad, a track ball, and the like.

The optical drive device 106 uses laser light or the like to read data recorded in an optical disk 24 or write data to the optical disk 24. The optical disk 24 is a portable recording medium in which data is recorded in a readable manner by reflection of light. Examples of the optical disk 24 include a digital versatile disc (DVD), a DVD-RAM, a compact disc read only memory (CD-ROM), a CD-recordable (R)/rewritable (RW), and the like.

The device coupling interface 107 is a communication interface for coupling the peripheral devices to the computer 100. For example, a memory device 25 and a memory reader/writer 26 may be coupled to the device coupling interface 107. The memory device 25 is a recording medium equipped with a communication function with the device coupling interface 107. The memory reader/writer 26 is a device that writes data to a memory card 27 or reads data from the memory card 27. The memory card 27 is a card-type recording medium.

The network interface 108 is coupled to a network 20. The network interface 108 exchanges data with another computer or communication device via the network 20. The network interface 108 is, for example, a wired communication interface coupled to a wired communication device such as a switch or a router with a cable. Furthermore, the network interface 108 may be a wireless communication interface that is coupled to and communicates with a wireless communication device such as a base station or an access point with radio waves.

The computer 100 may implement a processing function of the second embodiment with the above-described hardware. Note that the information processing apparatus 10 described in the first embodiment may also be implemented by hardware similar to that of the computer 100 illustrated in FIG. 2.

The computer 100 implements the processing function of the second embodiment by executing, for example, a program recorded on a computer-readable recording medium. The program in which processing content to be executed by the computer 100 is described may be recorded in various recording media. For example, the program to be executed by the computer 100 may be stored in the storage device 103. The processor 101 loads at least a part of the program in the storage device 103 into the memory 102, and executes the program. Furthermore, the program to be executed by the computer 100 may also be recorded in a portable recording medium such as the optical disk 24, the memory device 25, or the memory card 27. The program stored in the portable recording medium may be executed after being installed in the storage device 103 under the control of the processor 101, for example. Furthermore, the processor 101 may read the program directly from the portable recording medium and execute the program.

With such a computer 100, it is possible to perform data analysis using a questionnaire result. For example, the computer 100 analyzes a result of a questionnaire survey that is periodically conducted for the same purpose. In this case, if the number of questions included in the past questionnaire is too large, the following problems occur.

If the number of questions included in the questionnaire is too large, a burden of the respondent increases. As the burden of the respondent increases, it is more difficult to secure the sufficient number of respondents. Therefore, an organization that conducts the survey is concerned about a shortage of the number of respondents.

It is also conceivable to encourage the respondent to answer by giving a reward to the respondent. However, if the number of questions is too large, the reward is not sufficient for the burden of the respondent, and as a result, it is not possible to secure the sufficient number of respondents. Although an increase in the reward can increase the number of respondents, cost of the survey increases.

In view of such circumstances, the number of questions in the questionnaire survey is required to be small as possible, in a range in which quality of the questionnaire survey can be kept. The quality of the questionnaire survey can be evaluated, for example, by cluster analysis.

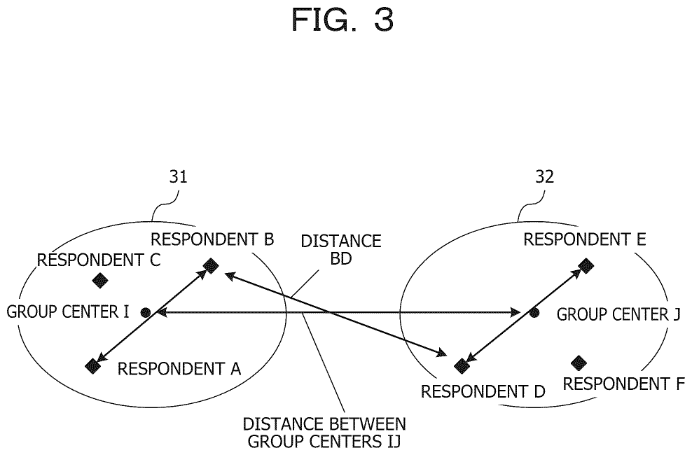

FIG. 3 is a diagram illustrating an example of quality evaluation of the questionnaire survey by the cluster analysis. For example, the computer 100 performs the cluster analysis based on an answer of each of a plurality of respondents to a questionnaire. In the cluster analysis, the plurality of respondents is classified into a single or a plurality of groups. In the example in FIG. 3, two groups 31 and 32 are illustrated.

Respondents A, B, and C belong to the group 31. Respondents D, E, and F belong to the group 32. An average answer of the respondents belonging to the group 31 is a group center I. Furthermore, an average answer of the respondents belonging to the group 32 is a group center J.

At this time, as commonality of the answers of the respondents belonging to each of the groups 31 and 32 is higher, a size of the group is smaller. Furthermore, as features of the answers of the belonging respondents are clearer for each of the groups 31 and 32, a distance between the group centers is larger. Therefore, it is considered that, as the sizes of the groups 31 and 32 generated by the cluster analysis are smaller and the distance between the group centers of the groups 31 and 32 is longer, the quality of the questionnaire survey is better.

A case will be considered where the number of questions is reduced from the questionnaire survey conducted in the past and a next questionnaire for the same purpose is conducted. At this time, to prevent a decrease in the quality of the questionnaire survey due to the reduction of the questions, for example, it is required to suppress an increase in the size of each group by the cluster analysis and to prevent the distance between the different groups from being shorter.

Therefore, sit is considered to perform the cluster analysis while reducing the number of questions little by little using the answers of the questionnaire survey conducted in the past and to confirm a degree of deterioration in the quality. For example, when the total number of questions is set to N (N is natural number) and the total number of questions to be deleted is set to M (M is natural number), the total number of combinations of the questions to be deleted is _{N}C_{M}. It is difficult to try the cluster analysis for all combination patterns within a range of realistic computer resources.

Therefore, the computer 100 more efficiently obtains a question that can be deleted, using a rule describing the features of the respondent. In the rule, a pattern of answers to a single or a plurality of questions is set as a condition part, and an answer to a single question different from the questions applied to the condition part is set as a conclusion part. A respondent whose answers to the questions in the condition part and the conclusion part indicated in the rule are the same as the rule is a respondent who can be described by the rule. The computer 100 specifies a rule to be applied to the questionnaire survey and sets a question used in the rule as a question used for the questionnaire survey. The computer 100 reduces the number of questions by reducing the number of rules to be applied to the questionnaire survey.

A basic policy for determining the rule to be applied to the questionnaire survey by the computer 100 is as follows. •All the respondents are correctly described. •Description is made to be easily understood as possible. •Description is made as accurately as possible. •The number of questions is reduced as possible.

With such a basic policy, the computer 100 adopts the following solutions. •The computer 100 specifies as few rules as possible, that can correctly describe all the respondents. •The computer 100 sets an upper limit of the number of rules to be used, in order not to impair understandability of an analysis result. •The computer 100 sets an upper limit of the number of respondents who have provided a wrong answer in a case of description using the rule, in order not to impair accuracy of the analysis result. •The computer 100 minimizes the number of questions used for the rule.

In the minimization of the number of questions used for the rule, the computer 100 obtains a combination (rule selection pattern) of the rules that minimizes the number of questions to be used for a questionnaire in the future, within a range of a constraint condition along the above basic policy.

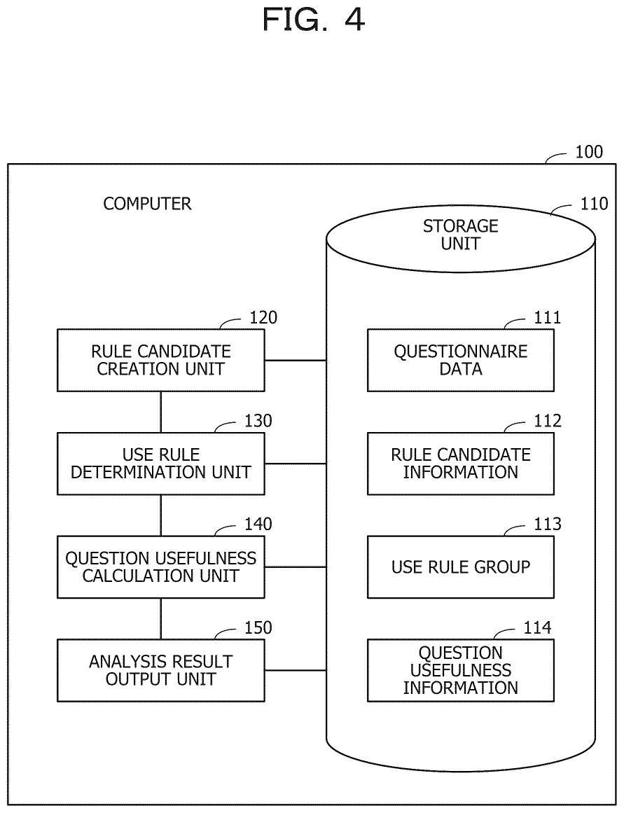

FIG. 4 is a block diagram illustrating functions of the computer for analyzing the question that can be deleted from the questionnaire survey. The computer 100 includes a storage unit 110, a rule candidate creation unit 120, a use rule determination unit 130, a question usefulness calculation unit 140, and an analysis result output unit 150.

The storage unit 110 stores questionnaire data 111, rule candidate information 112, a use rule group 113, and question usefulness information 114. The questionnaire data 111 is data indicating a question for a large number of respondents and answers to the question, in the questionnaire survey conducted in the past. The rule candidate information 112 is a set of candidates of a rule to be applied to the questionnaire survey in the future. The use rule group 113 is a set of rules to be applied to the questionnaire survey in the future. The question usefulness information 114 is information indicating usefulness of each of the questions indicated in the questionnaire data 111, in the questionnaire survey in the future.

The rule candidate creation unit 120 creates a plurality of rule candidates, based on the questionnaire data 111. The rule candidate creation unit 120 stores the plurality of created rules in the storage unit 110, as the rule candidate information 112.

The use rule determination unit 130 determines a rule recommended to be used for the questionnaire survey in the future, from among the rules included in the rule candidate information 112. The use rule determination unit 130 stores the determined rule in the storage unit 110, as the use rule group 113.

The question usefulness calculation unit 140 counts the number of times when each question is used for the rule included in the generated use rule group 113, in a case where the use rule group 113 is repeatedly generated while changing conditions. The question usefulness calculation unit 140 stores the counting result for each question in the storage unit 110, as the question usefulness information 114.

The analysis result output unit 150 outputs an analysis result of the question that can be deleted. For example, the analysis result output unit 150 displays the number of times when the rule to be applied or each question is used, on the monitor 21.

Note that, the function of each element illustrated in FIG. 4 can be implemented by executing a program module corresponding to the element by the processor 101, for example.

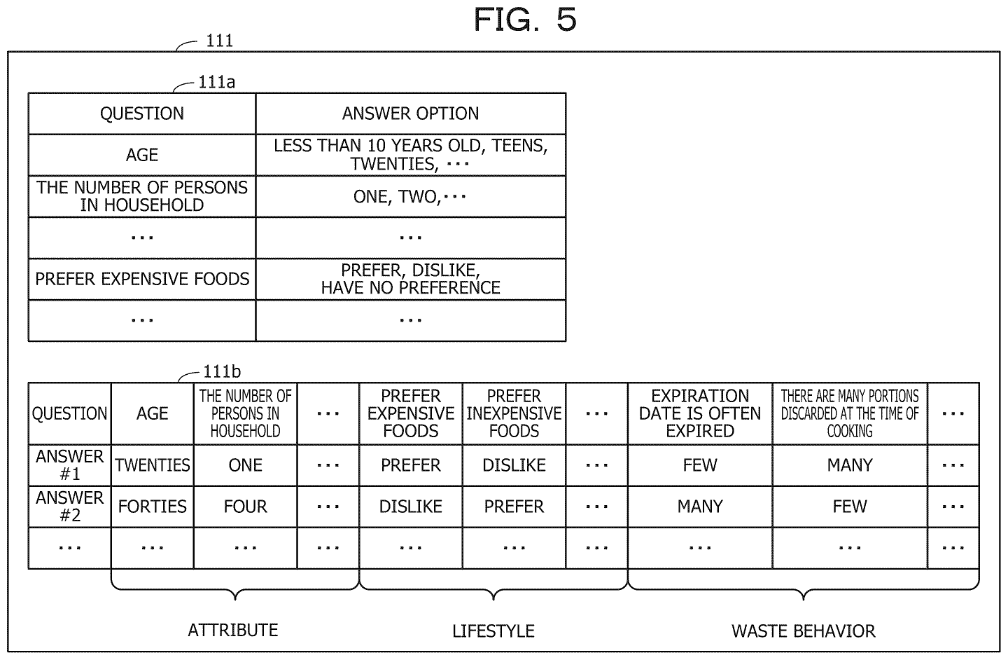

FIG. 5 is a diagram illustrating an example of the questionnaire data. The questionnaire data 111 includes question data 111a and answer data 111b. In the question data 111a, a question in a conducted questionnaire survey and answer options for the question are registered. The answer option is an option of an answer prepared in advance for the corresponding question. Note that the computer 100 may register an actual answer example from the respondent to the question, in the question data 111a, as the answer option.

In the answer data 111b, a record for each respondent who has answered the conducted questionnaire survey is registered. In each record of the answer data 111b, an answer to the question by the respondent is set, in association with the question included in the questionnaire survey.

In the example in FIG. 5, the questions include a question regarding an attribute of the respondent, a question regarding a lifestyle of the respondent, and a question regarding a food waste behavior of the respondent. For example, the question regarding the attribute of the respondent includes “age”, “the number of persons in household”, or the like. The question regarding the lifestyle of the respondent includes “prefer expensive foods” (likes, dislikes, and the like are answer options), “prefer inexpensive foods” (likes, dislikes, and the like are answer options), or the like. The question regarding the waste behavior includes questions such as “expiration date is often expired” (often, less often, and the like are answer options), “there are many portions discarded at the time of cooking” (many, few, and the like are answer options), or the like.

The computer 100 analyzes the question that can be deleted, based on the questionnaire data 111.

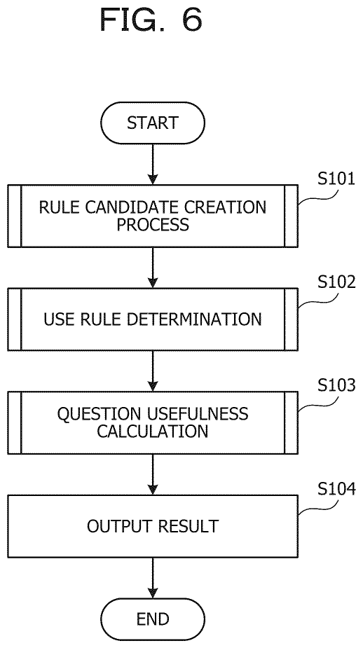

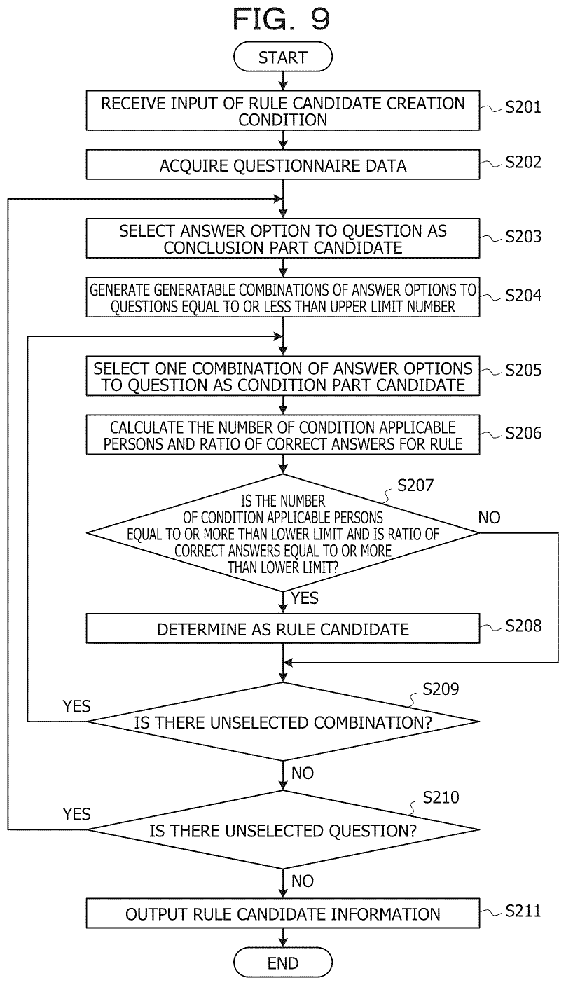

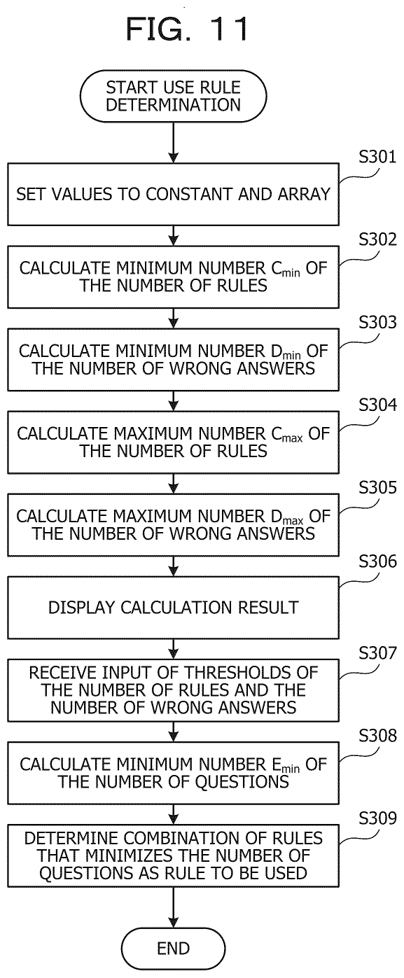

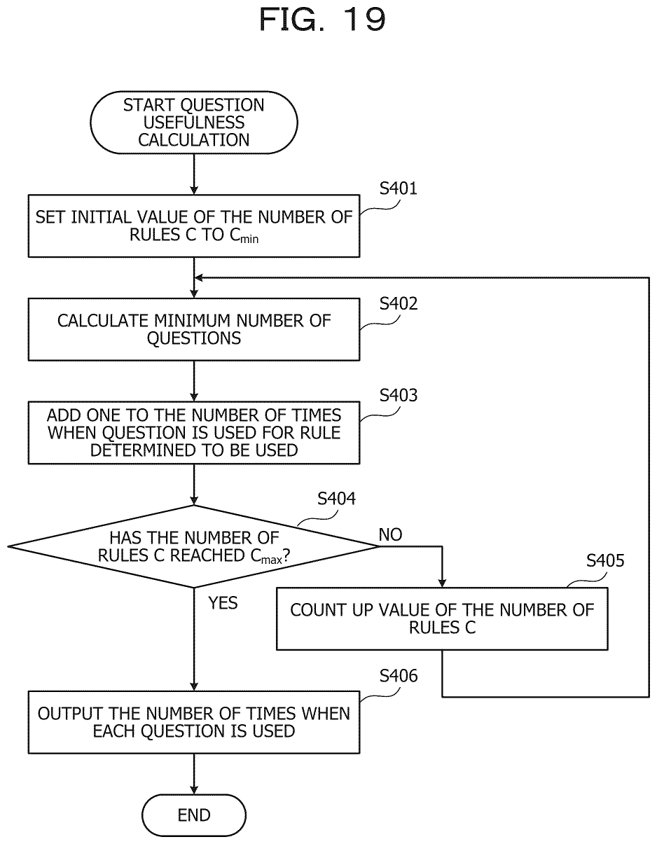

FIG. 6 is a flowchart illustrating an example of a procedure of a process for analyzing the question that can be deleted. Hereinafter, the process illustrated in FIG. 6 will be described in line with step numbers.
[Step S101] The rule candidate creation unit 120 creates the candidate of the rule by combining the questions set to the questionnaire data 111. For example, the rule candidate creation unit 120 creates a candidate of the plurality of rules in which the single or the plurality of questions is set as the condition part and the single question is set as the conclusion part. Details of a rule candidate creation process will be described later (refer to FIG. 9).
[Step S102] The use rule determination unit 130 determines the rule to be used, from among the created rule candidates. For example, the use rule determination unit 130 determines a single or a plurality of rules that can minimize the number of questions in a range satisfying a predetermined constraint condition, as a rule recommended to be used. Details of a use rule determination process will be described later (refer to FIG. 11).
[Step S103] The question usefulness calculation unit 140 calculates the usefulness of each question. Details of a question usefulness calculation process will be described later (refer to FIG. 19).
[Step S104] The analysis result output unit 150 outputs the analysis result of the question that can be deleted. For example, the analysis result output unit 150 displays the rule recommended to be used and a question included in the rule (held question without being deleted), on the monitor 21. Furthermore, the analysis result output unit 150 displays information indicating the usefulness of each rule on the monitor 21. For example, a question of which a numerical value indicating the usefulness (the number of times when question is used for rule) is “0” is the question that can be deleted from the questionnaire.

In this way, the question that can be deleted is presented to a user. The user conducts, for example, a questionnaire survey for requesting a respondent to answer a question that cannot be deleted (useful question), in next and subsequent questionnaire surveys. As a result, it is possible to conduct the questionnaire survey without applying an excessive burden to the respondent, and it is possible to obtain the answers from many respondents.

Next, the rule candidate creation process will be specifically described.

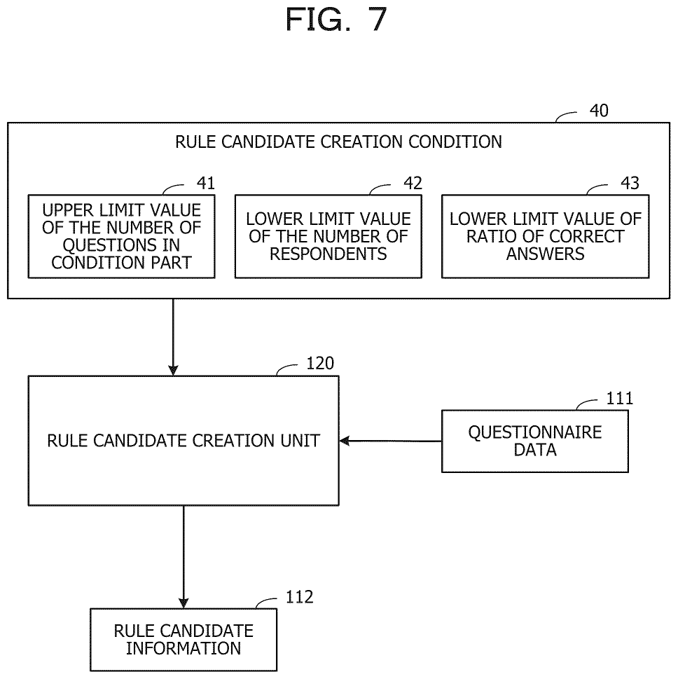

FIG. 7 is a diagram illustrating an example of the rule candidate creation process. For example, the rule candidate creation unit 120 receives an input of a rule candidate creation condition 40 from the user. The rule candidate creation condition 40 includes, for example, an upper limit value 41 of the number of questions in the condition part, a lower limit value 42 of the number of respondents, and a lower limit value 43 of the ratio of the correct answers.

The upper limit value 41 of the number of questions in the condition part is a maximum number of questions set to the condition part of the rule. If the number of questions in the condition part is too large, the number of respondents corresponding to the rule decreases, and there is a possibility that sample data is not statistically valid. Since the number of respondents corresponding to the rule depends on the total number of respondents for the questionnaire survey, the rule candidate creation unit 120 allows the user to arbitrarily set the upper limit value 41 of the number of questions in the condition part.

The lower limit value 42 of the number of respondents is a minimum value of the number of respondents corresponding to the used rule. If the number of respondents corresponding to the used rule is too small, there is a possibility that sample data is not statistically valid. Therefore, a rule of which the number of corresponding respondents is less than the lower limit value 42 of the number of respondents is excluded from the candidates to be used.

The lower limit value 43 of the ratio of the correct answers is a minimum value of the ratio of the respondents corresponding to the conclusion part of the rule (ratio of respondents who have provided correct answers), among the respondents corresponding to the condition part of the rule. In a case where the ratio of the respondents who have provided the correct answers is small, it cannot be said that the rule represents a feature common to the set of the respondents corresponding to the condition part. Therefore, a rule in which the ratio of the correct answer is less than the lower limit value 43 of the ratio of the correct answers is excluded from the candidate to be used.

The rule candidate creation unit 120 creates a candidate of a rule that satisfies the rule candidate creation condition 40, based on the questionnaire data 111. Then, the rule candidate creation unit 120 outputs the rule candidate information 112 indicating the created rule.

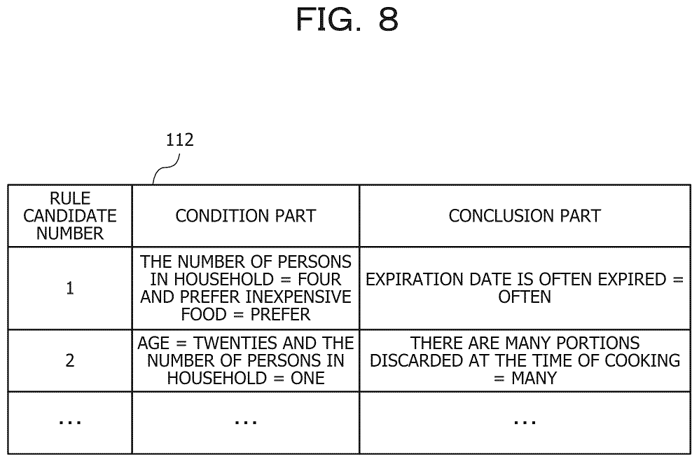

FIG. 8 is a diagram illustrating an example of the rule candidate information. In the rule candidate information 112, a record indicating content of the rule is registered, for each created rule candidate. For example, in the rule candidate information 112, the condition part and the conclusion part of the created rule are registered, in association with a rule candidate number.

For example, in a rule with a rule candidate number “1”, a condition part is “the number of persons in household=four and prefer inexpensive food=prefer”, and a conclusion part is “expiration date is often expired =often”. Furthermore, in a rule with a rule candidate number “2”, a condition part is “age=twenties and the number of persons in household=one”, and a conclusion part is “there are many portions discarded at the time of cooking=many”.

By comparing each rule indicated in the rule candidate information 112 with the answer data 111b, statistical information such as the ratio of the correct answers can be obtained. The ratio of the correct answers is a value obtained by dividing the number of respondents who have provided the correct answer by the number of condition applicable persons. The number of respondents who have provided the correct answer is the number of respondents who have provided the same answers as the condition part and the conclusion part, to both questions in the condition part and the conclusion part. The number of condition applicable persons is the number of respondents who have provided the same answer as the condition part, to the question in the condition part.

For example, in the rule with the rule candidate number “1”, it is assumed that the number of condition applicable persons be “300”, the number of respondents who have provided the correct answer be “200”, and the number of respondents who have provided the wrong answer be “100”. The number of respondents who have provided the wrong answer is the number of respondents who have provided the same answer as the condition part to the question in the condition part and have provided an answer different from the conclusion part to the question in the conclusion part. In this case, the ratio of the correct answer is “200/300=2/3”.

For example, in the rule with the rule candidate number “2”, it is assumed that the number of condition applicable persons be “150”, the number of respondents who have provided the correct answer be “120”, and the number of respondents who have provided the wrong answer be “30”. In this case, the ratio of the correct answer is “120/150=4/5”.

FIG. 9 is a flowchart illustrating an example of a procedure of the rule candidate creation process. Hereinafter, the process illustrated in FIG. 9 will be described in line with step numbers.
[Step S201] The rule candidate creation unit 120 receives an input of the rule candidate creation condition 40 by the user. The rule candidate creation unit 120 sets the upper limit value 41 of the number of questions in the condition part included in the rule candidate creation condition 40, the lower limit value 42 of the number of respondents, and the lower limit value 43 of the ratio of the correct answers, as parameters.
[Step S202] The rule candidate creation unit 120 acquires the questionnaire data 111 from the storage unit 110.
[Step S203] The rule candidate creation unit 120 selects one option of an answer to the question indicated in the questionnaire data 111 as a conclusion part candidate.
[Step S204] The rule candidate creation unit 120 generates all combinations of answer options to the questions that are equal to or less than the upper limit value 41 of the number of questions in the condition part, that can be generated from the questions other than questions of the conclusion part candidate.
[Step S205] The rule candidate creation unit 120 selects one unprocessed combination, from among the generated combinations of the answer options to the question and sets the selected combination as a condition part candidate.
[Step S206] The rule candidate creation unit 120 counts the number of respondents corresponding to the condition part candidate (the number of condition applicable persons), based on the questionnaire data 111. Furthermore, the rule candidate creation unit 120 counts the number of respondents corresponding to both of the condition part candidate and the conclusion part candidate (the number of respondents who have provided correct answer), based on the questionnaire data 111. Then, the rule candidate creation unit 120 calculates the ratio of the correct answers.
[Step S207] The rule candidate creation unit 120 determines whether or not a condition is satisfied that the number of condition applicable persons is equal to or more than the lower limit value 42 of the number of respondents and the correct answer ratio is equal to or more than the lower limit value 43 of the ratio of the correct answers. In a case where the condition is satisfied, the rule candidate creation unit 120 proceeds the process to step S208. Furthermore, in a case where the condition is not satisfied, the rule candidate creation unit 120 proceeds the process to step S209.
[Step S208] The rule candidate creation unit 120 determines a rule in which the answer option to the single question selected as the conclusion part candidate is set to the conclusion part and the combination of the answer options to the question selected as the condition part candidate is set to the condition part, as the rule candidate.
[Step S209] The rule candidate creation unit 120 determines whether or not there is an unselected combination, among the combinations of the answer options to the question, generated in step S204. If there is an unselected combination, the rule candidate creation unit 120 proceeds the process to step S205. Furthermore, if all the combinations have been selected, the rule candidate creation unit 120 proceeds the process to step S210.
[Step S210] The rule candidate creation unit 120 determines whether or not there is an unselected question as the conclusion part candidate, among the answer options to the question indicated in the questionnaire data 111. If there is an unselected question, the rule candidate creation unit 120 proceeds the process to step S203. Furthermore, if all the questions have been selected, the rule candidate creation unit 120 proceeds the process to step S211.
[Step S211] The rule candidate creation unit 120 outputs the rule candidate information 112 indicating the rule determined as the rule candidate. For example, the rule candidate creation unit 120 stores the rule candidate information 112 in the storage unit 110.

In this way, the rule that satisfies the rule candidate creation condition 40 is set to the rule candidate information 112 as the rule candidate to be used.

Next, the use rule determination process will be specifically described. The use rule determination unit 130 determines a use rule so as to minimize the number of questions. At that time, the use rule determination unit 130 uses at least one rule that correctly describes the respondent, for all the respondents.

Furthermore, the use rule determination unit 130 prevents the number of rules to be used from being excessively increased, in consideration of understandability of the rule. Furthermore, the use rule determination unit 130 prevents the number of respondents who have provided the wrong answer from being excessively increased, in consideration of accuracy of the rule. For example, the use rule determination unit 130 receives an input of a threshold of the number of rules to be used from the user and limits the number of rules to be used to be equal to or less than the threshold. Furthermore, the use rule determination unit 130 receives an input of a threshold of the number of wrong answers from the user and sets a total number of wrong answers of the rule to be used to be equal to or less than the threshold.

The use rule determination unit 130 can limit an allowable range of the threshold input by the user. For example, the use rule determination unit 130 calculates the minimum number “Cₘᵢₙ” and the maximum number “Cₘₐₓ” of the number of rules to be used and the minimum number “Dₘᵢₙ” and the maximum number “Dₘₐₓ” of the total number of wrong answers of the rule to be used.

Then, the use rule determination unit 130 receives a value within a range from the minimum number “Cₘᵢₙ” to the maximum number “Cₘₐₓ” of the number of rules to be used, as the threshold of the number of rules. Furthermore, the use rule determination unit 130 receives a value within a range from the minimum number “Dₘᵢₙ” to the maximum number “Dₘₐₓ” of the number of wrong answers, as the threshold of the number of wrong answers.

When the total number of respondents who have provided the wrong answer for each rule to be used is set as the number of wrong answers, the number of rules to be used and the number of wrong answers have a certain relationship.

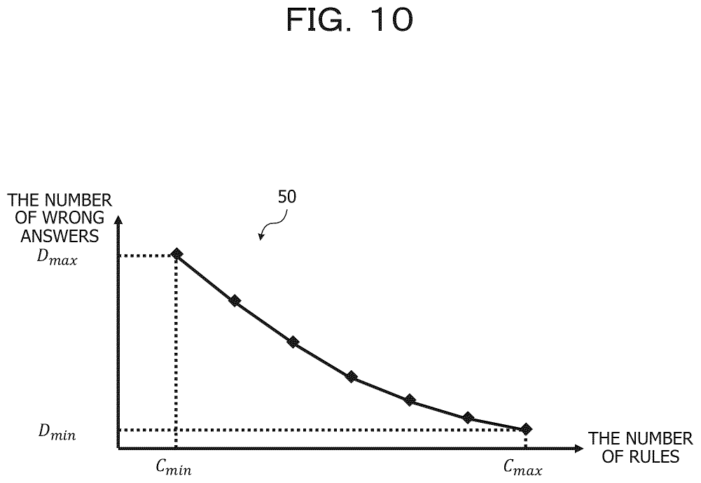

FIG. 10 is a diagram illustrating an example of a relationship between the number of rules and the number of wrong answers. In a graph 50, the horizontal axis indicates the number of rules, and the vertical axis indicates the number of wrong answers. In the graph 50, the number of wrong answers according to the number of rules is indicated by a polygonal line. As illustrated in the graph 50, as the number of rules increases, the number of wrong answers decreases.

The minimum number “Cₘᵢₙ” of the number of rules to be used is the minimum number of the rules to be used, that can correctly describe all the respondents, by any one of the rules to be used. The minimum number “Dₘᵢₙ” of the number of respondents who have provided the wrong answer is the minimum number of the wrong answers of the rule to be used, that can correctly describe all the respondents, by any one of the rules to be used.

The maximum number “Cₘₐₓ” of the number of rules to be used is the minimum number of the rules to be used, that can correctly describe all the respondents, by any one of the rules to be used, in a case where the number of wrong answers is limited to be equal to or less than the minimum number “Dₘᵢₙ”. The maximum number “Dₘₐₓ” of the number of wrong answers is the minimum number of the number of wrong answers of the rule to be used, that can correctly describe all the respondents, by any one of the rules to be used, in a case where the number of rules is limited to be equal to or less than the minimum number “Cₘᵢₙ”.

FIG. 11 is a flowchart illustrating an example of a procedure of the use rule determination process. Hereinafter, the process illustrated in FIG. 11 will be described in line with step numbers.
[Step S301] The use rule determination unit 130 sets values to a constant and an array used for calculation for determining the rule recommended to be used. The values of the constant and the array are obtained based on the questionnaire data 111 and the rule candidate information 112.
[Step S302] The use rule determination unit 130 calculates the minimum number “Cₘᵢₙ” of the number of rules. For example, the use rule determination unit 130 sets the smallest number of rules under a condition that all the respondents are correctly described, as the minimum number “Cₘᵢₙ”.
[Step S303] The use rule determination unit 130 calculates the minimum number “Dₘᵢₙ” of the number of wrong answers. For example, the use rule determination unit 130 sets the number of wrong answers in the set of the rules that can provide accurate description as possible (reduce the number of wrong answers) under a condition that all the respondents are correctly described, as the minimum number “Dₘᵢₙ” of the number of wrong answers.
[Step S304] The use rule determination unit 130 calculates the maximum number “Cₘₐₓ” of the number of rules. For example, the use rule determination unit 130 sets the number of sets of the rules that can provide description that is easily understood as possible (the number of rules is small), under a condition that all the respondents can be correctly described and can be accurately described as possible, as the maximum number “Cₘₐₓ” of the number of rules.
[Step S305] The use rule determination unit 130 calculates the maximum number “Dₘₐₓ” of the number of wrong answers. For example, the use rule determination unit 130 sets the number of wrong answers in the set of rules that can accurately provide description as possible, under a condition that all the respondents can be correctly described and are described to be easily understood as possible, as the maximum number “Dₘₐₓ” of the number of wrong answers.
[Step S306] The use rule determination unit 130 displays calculation results of the minimum number “Cₘᵢₙ” of the number of rules, the minimum number “Dₘᵢₙ” of the number of wrong answers, the maximum number “Cₘₐₓ” of the number of rules, and the maximum number “Dₘₐₓ” of the number of wrong answers, for example, on the monitor 21.
[Step S307] The use rule determination unit 130 receives inputs of a threshold “C_{threshold}” of the number of rules and a threshold “D_{threshold}” of the number of wrong answers, from the user. The use rule determination unit 130 receives a value within a range from the minimum number “Cₘᵢₙ” of the number of rules to the maximum number “Cₘₐₓ” of the number of rules, as the threshold “C_{threshold}” of the number of rules. The use rule determination unit 130 receives a value within a range from the minimum number “Dₘᵢₙ” of the number of wrong answers to the maximum number “Dₘₐₓ” of the number of wrong answers, as the threshold “D_{threshold}” of the number of wrong answers.
[Step S308] The use rule determination unit 130 calculates a minimum number “Eₘᵢₙ” of questions. For example, the use rule determination unit 130 obtains a set of rules that satisfies conditions that all the respondents are correctly described, the number of rules is equal to or less than the threshold “C_{threshold}”, and the number of wrong answers is equal to or less than the threshold “D_{threshold}”, and in which the number of used questions is minimized. The use rule determination unit 130 sets the number of questions used in any one of the obtained combinations of the rules as the minimum number “Eₘᵢₙ”.
[Step S309] The use rule determination unit 130 determines a rule included in the combination of the rules with the minimum number of questions as the rule recommended to be used in the questionnaire survey in the future. In the questionnaire survey in the future, collection of answers to the questions used in the used rules is performed.

In this way, the rule recommended to be used is determined from among the rule candidates. Hereinafter, the process illustrated in FIG. 11 will be specifically described.

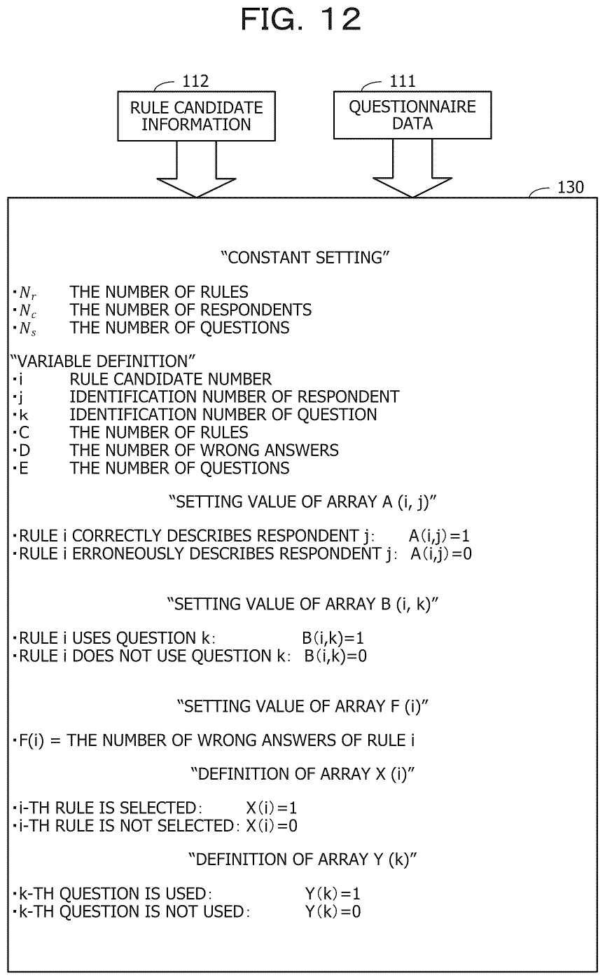

FIG. 12 is a diagram illustrating an example of the set constant and array. The use rule determination unit 130 sets the number of rules set to the rule candidate information 112 to a constant “Nᵣ”. Furthermore, the use rule determination unit 130 sets the number of records registered in the answer data 111b in the questionnaire data 111 to a constant “N_{c}”, as the number of respondents. Moreover, the use rule determination unit 130 sets the number of questions indicated in the question data 111a in the questionnaire data 111, to a constant “Nₛ”.

The use rule determination unit 130 defines variables used for calculation. A variable “i” is a value indicating a rule candidate number. A variable “j” is a value indicating an identification number of a respondent. A variable “k” is a value indicating an identification number of a question. A variable “C” is a value indicating the number of rules. A variable “D” is a value indicating the number of wrong answers. A variable “E” is a value indicating the number of questions.

The use rule determination unit 130 sets a value to an array A (i, j). In a case where an i-th rule can correctly describe a j-th respondent (answers to questions in condition part and conclusion part are as in rule), the use rule determination unit 130 sets “A (i, j)=1”. Furthermore, in a case where the i-th rule erroneously describes the j-th respondent (at least a part of answers to questions in condition part and conclusion part are different from rule), the use rule determination unit 130 sets “A (i, j)=0”.

The use rule determination unit 130 sets a value to an array B (i, k). In a case where the i-th rule uses a k-th question, the use rule determination unit 130 sets “B (i, k)=1”. Furthermore, in a case where the i-th rule does not use the k-th question, the use rule determination unit 130 sets “B (i, k)=0”.

The use rule determination unit 130 sets the number of wrong answers of the i-th rule, to an array F (i).

Furthermore, the use rule determination unit 130 defines an array to be used in a calculation process. For example, the use rule determination unit 130 defines an array X (i). In a case of selecting the i-th rule, the use rule determination unit 130 sets “X (i)=1”. Furthermore, in a case of not selecting the i-th rule, the use rule determination unit 130 sets “X (i)=0”.

Furthermore, the use rule determination unit 130 defines an array Y (k). In a case of using the k-th question in the questionnaire survey, the use rule determination unit 130 sets “Y (k)=1”. Furthermore, in a case of not using the k-th question in the questionnaire survey, the use rule determination unit 130 sets “Y (k)=0”.

The use rule determination unit 130 performs calculation using the constants, the variables, and the arrays illustrated in FIG. 12 and determines the rule recommended to be used.

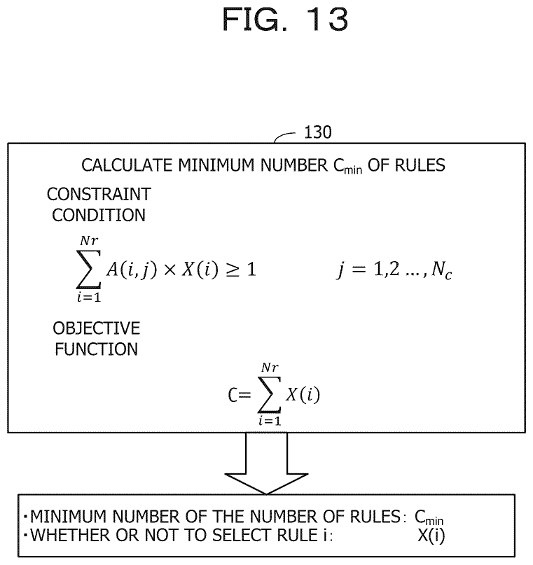

FIG. 13 is a diagram illustrating an example of a method for calculating the minimum number of the number of rules. For example, the use rule determination unit 130 searches for a solution of a combination optimization problem that minimizes a value of an objective function in the formula (2), using the formula (1) as a constraint condition.

$$\begin{matrix}[ Expression 1 ] & \\ {\sum }_{i = 1}^{{N}_{r}} A ( i , j ) \times X ( i ) \geq 1 j = 1 , 2 , … , {N}_{c} & ( 1 )\end{matrix}$$

$$\begin{matrix}[ Expression 2 ] & \\ C = {\sum }_{i = 1}^{{N}_{r}} X ( i ) & ( 2 )\end{matrix}$$

The formula (1) is a formula that satisfies correct description of all the respondents. In a case where the j-th respondent coincides at least one of the selected rules, the formula (1) is satisfied. For all “j” (j=1, 2, . . . , N_{c}), it is required to satisfy the formula (1). The objective function indicated in the formula (2) indicates the number of rules selected as the combination of the rules. As the number of selected rules is smaller, the features of all the respondents are described in a clarifying manner, by the combination of the selected rules. A minimum value of the objective function is the minimum number “Cₘᵢₙ” of the number of rules.

When the minimum value of the objective function in the formula (2) is obtained, the use rule determination unit 130 outputs the minimum number “Cₘᵢₙ” of the number of rules and the array X (i) indicating the combination of the rules selected at that time. The combination of the rules of which the value in the array X (i) at this time is “1” is an example of the second rule selection pattern described in the first embodiment.

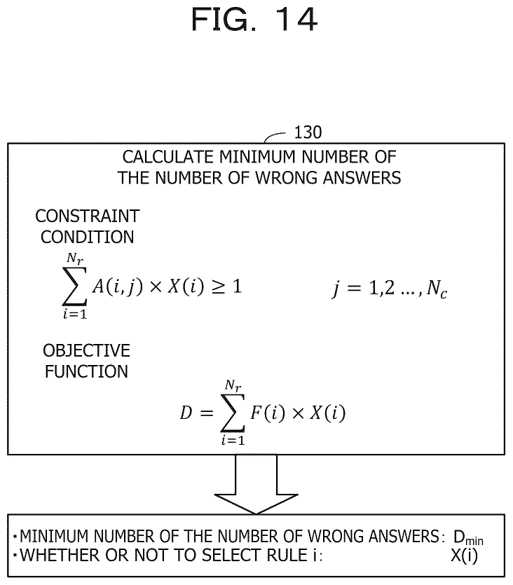

FIG. 14 is a diagram illustrating an example of a method for calculating the minimum number of the number of wrong answers. For example, the use rule determination unit 130 searches for a solution of a combination optimization problem that minimizes a value of an objective function in the formula (3), using the above formula (1) as a constraint condition.

$$\begin{matrix}[ Expression 3 ] & \\ D = {\sum }_{i = 1}^{{N}_{r}} F ( i ) \times X ( i ) & ( 3 )\end{matrix}$$

The objective function indicated in the formula (3) indicates a total number of wrong answers for each of the rules selected as the combination of the rules. As the total number of wrong answers is smaller, each of the selected rules accurately describes the features of the respondent. A minimum value of the objective function is the minimum number “Dₘᵢₙ” of the number of wrong answers.

When the minimum value of the objective function in the formula (3) is obtained, the use rule determination unit 130 outputs the minimum number “Dₘᵢₙ” of the number of wrong answers and the array X (i) indicating the combination of the rules selected at that time. The combination of the rules of which the value in the array X (i) at this time is “1” is an example of the third rule selection pattern described in the first embodiment.

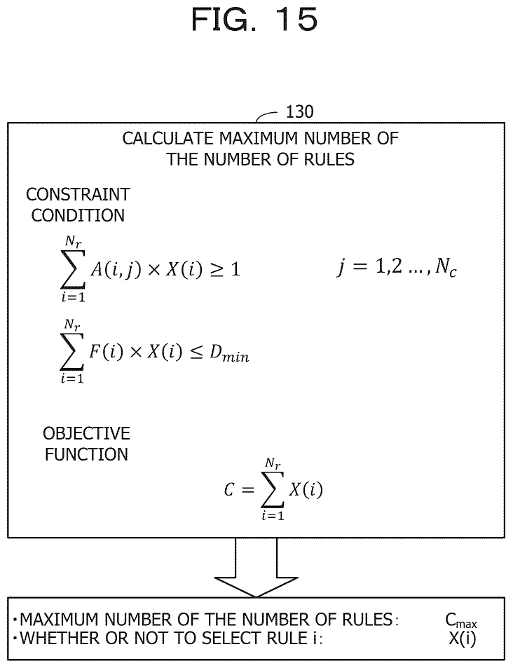

FIG. 15 is a diagram illustrating an example of a method for calculating the maximum number of the number of rules. For example, the use rule determination unit 130 searches for a solution of a combination optimization problem that minimizes the value of the objective function in the above formula (2), using the above formula (1) and the following formula (4) as constraint conditions.

$$\begin{matrix}[ Expression 4 ] & \\ {\sum }_{i = 1}^{{N}_{r}} F ( i ) \times X ( i ) \leq {D}_{min} & ( 4 )\end{matrix}$$

The formula (4) is a condition that each of the selected rules accurately describes the features of the respondent as possible. The minimum value of the objective function is the maximum number “Cₘₐₓ” of the number of rules.

When the minimum value of the objective function in the formula (2) is obtained, the use rule determination unit 130 outputs the maximum number “Cₘₐₓ” of the number of rules and the array X (i) indicating the combination of the rules selected at that time. The combination of the rules of which the value in the array X (i) at this time is “1” is an example of the fourth rule selection pattern described in the first embodiment.

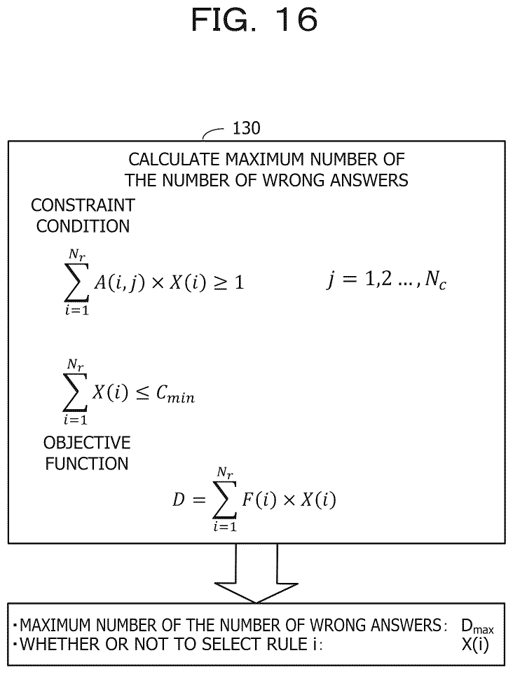

FIG. 16 is a diagram illustrating an example of a method for calculating the maximum number of the number of wrong answers. For example, the use rule determination unit 130 searches for a solution of a combination optimization problem that minimizes the value of the objective function in the above formula (3), using the above formula (1) and the following formula (5) as constraint conditions.

$$\begin{matrix}[ Expression 5 ] & \\ {\sum }_{i = 1}^{{N}_{r}} X ( i ) \leq {C}_{min} & ( 5 )\end{matrix}$$

The formula (5) is a condition that the combination of the selected rules describes the features of all the respondents to be easily understood as possible. A minimum value of the objective function is the maximum number “Dₘₐₓ” of the number of wrong answers.

When the minimum value of the objective function in the formula (3) is obtained, the use rule determination unit 130 outputs the maximum number “Dₘₐₓ” of the number of wrong answers and the array X (i) indicating the combination of the rules selected at that time. The combination of the rules of which the value in the array X (i) at this time is “1” is an example of the fifth rule selection pattern described in the first embodiment.

When obtaining the minimum number “Cₘᵢₙ” of the number of rules, the minimum number “Dₘᵢₙ” of the number of wrong answers, the maximum number “Cₘₐₓ” of the number of rules, and the maximum number “Dₘₐₓ” of the number of wrong answers, the use rule determination unit 130 presents these values to the user and receives an input of the thresholds.

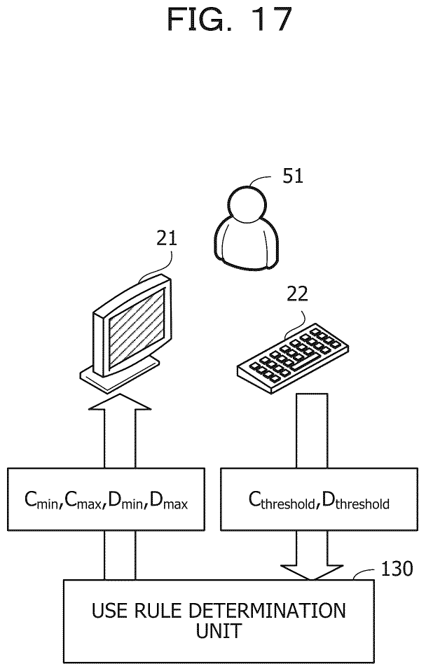

FIG. 17 is a diagram illustrating an example of an operation reception of the user. For example, the use rule determination unit 130 displays the minimum number “Cₘᵢₙ” of the number of rules, the minimum number “Dₘᵢₙ” of the number of wrong answers, the maximum number “Cₘₐₓ” of the number of rules, and the maximum number “Dₘₐₓ” of the number of wrong answers, on the monitor 21. A user 51 refers to the displayed information and inputs the threshold “C_{threshold}” of the number of rules and the threshold “D_{threshold}” of the number of wrong answers, using an input device such as the keyboard 22.

For example, in a case of considering that the understandability of the rule is important, the user 51 sets the threshold “C_{threshold}” of the number of rules to a lower value. Furthermore, in a case of considering that the accuracy of the rule is important, the user 51 sets the threshold “D_{threshold}” of the number of wrong answers to a lower value. The use rule determination unit 130 acquires the input value.

The use rule determination unit 130 calculates the minimum number of questions, using the threshold “C_{threshold}” of the number of rules and the threshold “D_{threshold}” of the number of wrong answers.

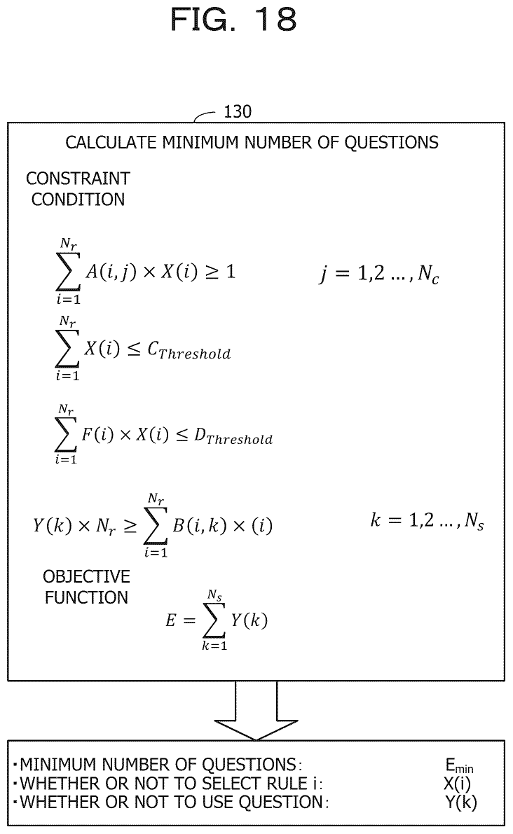

FIG. 18 is a diagram illustrating an example of a method for calculating the minimum number of questions. For example, the use rule determination unit 130 searches for a solution of a combination optimization problem that minimizes a value of an objective function in the formula (9), using the above formula (1) and the following formulae (6) to (8) as constraint conditions.

$$\begin{matrix}[ Expression 6 ] & \\ {\sum }_{i = 1}^{{N}_{r}} X ( i ) \leq {C}_{threshold} & ( 6 )\end{matrix}$$

$$\begin{matrix}[ Expression 7 ] & \\ {\sum }_{i = 1}^{{N}_{r}} F ( i ) \times X ( i ) \leq {D}_{threshold} & ( 7 )\end{matrix}$$

$$\begin{matrix}[ Expression 8 ] & \\ Y ( k ) \times {N}_{r} \geq {\sum }_{i = 1}^{{N}_{r}} B ( i , k ) \times X ( i ) k = 1 , 2 , … , {N}_{s} & ( 8 )\end{matrix}$$

$$\begin{matrix}[ Expression 9 ] & \\ E = {\sum }_{k = 1}^{{N}_{s}} Y ( k ) & ( 9 )\end{matrix}$$

The formula (6) indicates that the rules are combined to achieve understandability within a range allowed by the user. The formula (7) indicates that the rules are combined so as to secure accuracy within a range allowed by the user. The formula (8) indicates that only a question used in any one of the selected rules is used in the questionnaire survey. The objective function in the formula (9) indicates the number of questions used in the questionnaire survey. A minimum value of the objective function is the minimum number “Eₘᵢₙ” of the number of questions.

When obtaining the minimum value of the objective function in the formula (9), the use rule determination unit 130 outputs the minimum number “Eₘᵢₙ” of the number of questions, the array X (i) indicating the combination of the rules selected at that time, and the array Y (k) indicating the question to be used. The combination of the rules of which the value of the array X (i) output at this time is “1” is an example of the second rule selection pattern described in the first embodiment. Each rule of which the value of the array X (i) is “1” is a rule recommended to be used in the questionnaire survey in the future. Furthermore, the question of which the value of the output array Y (k) is “1” is a question recommended to be used in the questionnaire survey in the future.

In this way, the rule and the question recommended to be used in the questionnaire survey are determined. For example, by collecting answers from the respondents to the questions recommended to be used, an examiner can obtain a survey result that can correctly and easily describes the features of all the respondents although the number of questions is small. In addition, since the number of questions is small, it is easy to obtain the answers from the sufficient number of respondents.

Furthermore, the computer 100 can quantify and present the usefulness of the question, for each question.

FIG. 19 is a flowchart illustrating an example of a procedure of the usefulness calculation process. Hereinafter, the process illustrated in FIG. 19 will be described in line with step numbers.
[Step S401] The question usefulness calculation unit 140 sets an initial value of the number of rules C to Cₘᵢₙ.
[Step S402] The question usefulness calculation unit 140 calculates the minimum number of questions, by searching for the solution of the combination optimization problem similarly to the process illustrated in FIG. 18. At this time, the question usefulness calculation unit 140 uses, for example, the number of rules C, as the threshold “C_{threshold}” of the number of rules. Furthermore, as the threshold “D_{threshold}” of the number of wrong answers, a value designated by the user is used. As a result, the number of questions E that satisfies the constraint conditions of the threshold “C_{threshold}” of the number of rules and the threshold “D_{threshold}” of the number of wrong answers is minimized.
[Step S403] The question usefulness calculation unit 140 adds “1” to the number of used times of an answer to the question used in the rule determined to be used, as a result of minimizing the number of questions.
[Step S404] The question usefulness calculation unit 140 determines whether or not the number of rules C has reached Cₘₐₓ. In a case where the number of rules C has reached Cₘₐₓ, the question usefulness calculation unit 140 proceeds the process to step S406. In a case where the number of rules C does not reach Cₘₐₓ, the question usefulness calculation unit 140 proceeds the process to step S405.
[Step S405] The question usefulness calculation unit 140 counts up a value of the number of rules C. Thereafter, the question usefulness calculation unit 140 proceeds the process to step S402.
[Step S406] The question usefulness calculation unit 140 outputs the number of times when each question is used. The number of times when each question is used indicates the usefulness of the question. In this way, the usefulness of the question is calculated.

The rule to be used in the questionnaire survey in the future is displayed by the analysis result output unit 150 as an analysis result.

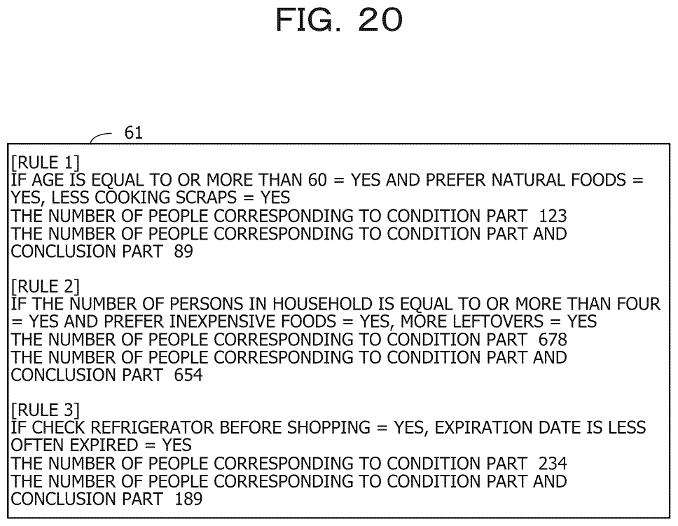

FIG. 20 is a diagram illustrating an example of the analysis result regarding the rule to be used. For example, an analysis result 61 as illustrated in FIG. 20 is displayed on the monitor 21. In the analysis result 61, the rule determined, by the use rule determination unit 130, to be used in the questionnaire survey is indicated. Furthermore, in the answer data 111b, the number of people corresponding to the condition part of the rule, the number of people corresponding to both of the condition part and the conclusion part, or the like is indicated.

Furthermore, the number of times when the answer to the question is used for the rule is displayed by the analysis result output unit 150, as the analysis result of the usefulness of each question.

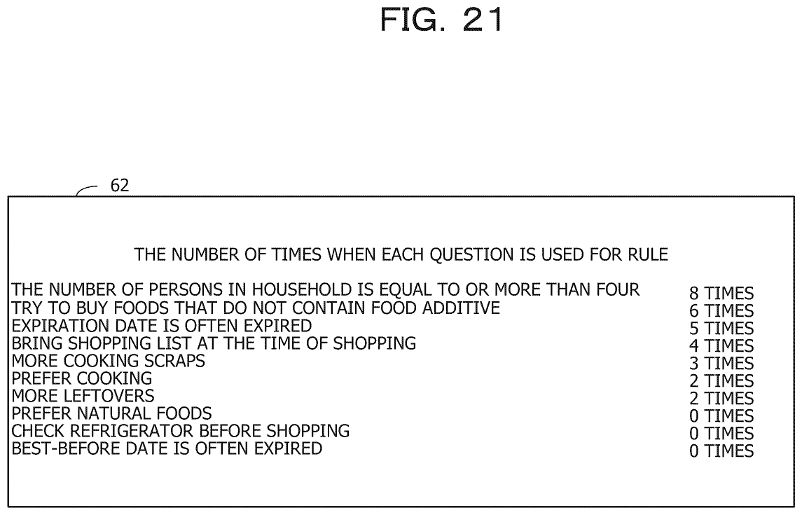

FIG. 21 is a diagram illustrating an example of the analysis result regarding the usefulness of the question. For example, an analysis result 62 as illustrated in FIG. 21 is displayed on the monitor 21. In the analysis result 62, the number of times when each question is used for the rule determined to be used, in a case where the number of rules C is changed and the number of questions is minimized, is indicated.

A question more frequently used has higher usefulness. In the example in FIG. 21, the question “the number of persons in household is equal to or more than four” (answer option is “equal to or more than four” or “less than four”) is used for the rule eight times. Therefore, this question has higher usefulness.

On the other hand, the number of times when the question “best-before date is often expired” (answer option is “often”, “less often”, or the like) is used for the rule is “0” times. This question has low usefulness.

In this way, by indicating the usefulness of each question as a numerical value, in a case where there are similar questions or the like, it is possible to easily determine which question is appropriate to be deleted. For example, as a cause of too many questions, there is a case where the plurality of similar questions is included. In this case, although it is considered that it is possible to delete any one of the similar questions, it is difficult to determine which question is deleted if there is no determination index. If the number of times when each question is used for the rule is indicated as illustrated in FIG. 21, in a case where there are similar questions, it can be easily determined that it is appropriate to delete the question of which the number of times of use is smaller.

### Other Embodiments

An object of the technology described in the second embodiment is to reduce the number of questions in the questionnaire survey regarding the food waste. However, the technology can be used to reduce the number of questions in other various questionnaire surveys.

The combination optimization problem implemented in the second embodiment may be solved by using a device specialized to solve the combination optimization problem, for example. For example, by converting the combination optimization problem into an Ising model or a quadratic unconstrained binary optimization (QUBO) problem, the combination optimization problem can be solved by an Ising machine. The Ising machine is a computer that specializes in an optimization problem of an Ising model that is one of magnetic models of physics. By using the Ising machine, search for a solution of the combination optimization problem can be efficiently performed. The Ising machine includes a quantum annealing machine using superconducting quantum bits, a coherent Ising machine using light characteristics as artificial spins, and a machine that solves a combination optimization problem with a digital circuit inspired by quantum phenomena.

While the embodiments have been exemplified thus far, the configuration of each unit illustrated in the embodiments may be replaced with another configuration having a similar function. Furthermore, other optional components and steps may be added. Moreover, any two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a questionnaire data analysis program for causing a computer to execute processing comprising:
generating a plurality of rules that indicates an answer pattern to two or more questions included in a plurality of questions, based on questionnaire data that indicates answers of a plurality of respondents to each of the plurality of questions in a conducted questionnaire survey;
specifying a respondent who has provided a correct answer that is same as an answer pattern to a question indicated in a rule, for each of the plurality of rules, based on the questionnaire data; and
determining a first rule selection pattern, based on the number of questions included in a single or a plurality of selected rules, from among rule selection patterns that satisfy a first constraint condition that each of the plurality of respondents is specified as the respondent who has provided the correct answer by any one of the single or the plurality of selected rules, among a plurality of rule selection patterns generated by selecting the single or the plurality of rules from among the plurality of rules.

2. The non-transitory computer-readable recording medium according to claim 1, wherein
in the processing of determining the first rule selection pattern, the first rule selection pattern is determined from among rule selection patterns that satisfy a second constraint condition that the number of selected rules is equal to or less than a first threshold, in addition to the first constraint condition, among the plurality of rule selection patterns.

3. The non-transitory computer-readable recording medium according to claim 2, wherein
in the processing of determining the first rule selection pattern, a second rule selection pattern of which the number of selected rules is the smallest is specified from among the rule selection patterns that satisfy the first constraint condition, and a value equal to or more than the number of rules in the second rule selection pattern is set as the first threshold.

4. The non-transitory computer-readable recording medium according to claim 1, wherein
in the processing of generating the plurality of rules, the plurality of rules is generated in which the answer pattern to the plurality of questions is divided into a first answer pattern to a question in a condition part and a second answer pattern to a question in a conclusion part,
the questionnaire data analysis program for causing the computer to execute processing further comprising:
specifying a respondent who has provided a wrong answer, has provided an answer same as the first answer pattern to the question in the condition part, and has provided an answer different from the second answer pattern to the question in the conclusion part, for each of the plurality of rules, based on the questionnaire data, and
in the processing of determining the first rule selection pattern, the first rule selection pattern is determined from among rule selection patterns that satisfy a third constraint condition that a total number of respondents who have provided the wrong answer for each of the selected rules is equal to or less than a second threshold, in addition to the first constraint condition, among the plurality of rule selection patterns.

5. The non-transitory computer-readable recording medium according to claim 4, wherein
in the processing of determining the first rule selection pattern, a third rule selection pattern of which the total number of respondents who have provided the wrong answer for each of the selected rules is the smallest is specified, from among the rule selection patterns that satisfy the first constraint condition, and a value equal to or more than the total number of respondents who have provided the wrong answer for each of the rules in the third rule selection pattern is set as the second threshold.

6. The non-transitory computer-readable recording medium according to claim 1, wherein
in the processing of generating the plurality of rules, the plurality of rules is generated in which the answer pattern to the plurality of questions is divided into a first answer pattern to a question in a condition part and a second answer pattern to a question in a conclusion part,
the questionnaire data analysis program for causing the computer to execute processing further comprising:
specifying a respondent who has provided a wrong answer, has provided an answer same as the first answer pattern to the question in the condition part, and has provided an answer different from the second answer pattern to the question in the conclusion part, for each of the plurality of rules, based on the questionnaire data, and
in the processing of determining the first rule selection pattern,
a second rule selection pattern of which the number of selected rules is the smallest is specified, from among the rule selection patterns that satisfy the first constraint condition,
a third rule selection pattern of which the total number of respondents who have provided the wrong answer for each of the selected rules is the smallest is specified, from among the rule selection patterns that satisfy the first constraint condition,
a fourth rule selection pattern of which the number of selected rules is the smallest is specified, from among rule selection patterns that satisfy the first constraint condition and of which the total number of respondents who have provided the wrong answer for each of the selected rules is equal to or less than the total number of respondents who have provided the wrong answer in the third rule selection pattern, among the plurality of rule selection patterns,
a fifth rule selection pattern of which the total number of respondents who have provided the wrong answer for each of the selected rules is the smallest is specified, from among rule selection patterns that satisfy the first constraint condition and of which the number of selected rules is equal to or less than the second rule selection pattern, among the plurality of rule selection patterns,
a value equal to or more than the number of rules in the second rule selection pattern and equal to or less than the number of rules in the fourth rule selection pattern is set as a first threshold,
a value equal to or more than the total number of respondents who have provided the wrong answer for each rule in the third rule selection pattern and equal to or less than the total number of respondents who have provided the wrong answer for each rule in the fifth rule selection pattern is set as a second threshold, and
the first rule selection pattern is determined, from among rule selection patterns that satisfy a second constraint condition that the number of selected rules is equal to or less than the first threshold and a third constraint condition that the number of respondents who have provided the wrong answer for each of the selected rules is equal to or less than the second threshold, in addition to the first constraint condition, among the plurality of rule selection patterns.

7. The non-transitory computer-readable recording medium according to claim 1, wherein
the processing of determining the first rule selection pattern is repeatedly executed, while changing a condition required for the plurality of generated rule selection patterns, and
the number of times when each of the plurality of questions is used in a rule selected in each of the repeatedly determined first rule selection patterns is counted.

8. The non-transitory computer-readable recording medium according to claim 1, wherein
in the processing of generating the plurality of rules, the plurality of rules is generated in which the answer pattern to the plurality of questions is divided into a first answer pattern to a question in a condition part and a second answer pattern to a question in a conclusion part,
the questionnaire data analysis program for causing the computer to execute processing further comprising:
calculating the number of condition applicable persons who have provided an answer same as the first answer pattern to the question in the condition part, for each of the plurality of rules, based on the questionnaire data, and
in the processing of determining the first rule selection pattern, a rule of which the number of condition applicable persons is less than a predetermined value, among the plurality of rules, is excluded from a selection target in the generation of the plurality of rule selection patterns.

9. The non-transitory computer-readable recording medium according to claim 1, wherein
in the processing of generating the plurality of rules, the plurality of rules is generated in which the answer pattern to the plurality of questions is divided into a first answer pattern to a question in a condition part and a second answer pattern to a question in a conclusion part,
the questionnaire data analysis program for causing the computer to execute processing further comprising:
calculating a ratio of the respondents who have provided the correct answer same as the second answer pattern to the question in the conclusion part, from among the number of condition applicable persons who have provided the same answer as the first answer pattern to the question in the condition part, for each of the plurality of rules, based on the questionnaire data, and
in the processing of determining the first rule selection pattern, a rule of which the ratio of the respondents who have provided the correct answer is less than a predetermined value, from among the plurality of rules, is excluded from a selection target in the generation of the plurality of rule selection patterns.

10. A questionnaire data analysis method comprising:
generating a plurality of rules that indicates an answer pattern to two or more questions included in a plurality of questions, based on questionnaire data that indicates answers of a plurality of respondents to each of the plurality of questions in a conducted questionnaire survey;
specifying a respondent who has provided a correct answer that is same as an answer pattern to a question indicated in a rule, for each of the plurality of rules, based on the questionnaire data; and
determining a first rule selection pattern, based on the number of questions included in a single or a plurality of selected rules, from among rule selection patterns that satisfy a first constraint condition that each of the plurality of respondents is specified as the respondent who has provided the correct answer by any one of the single or the plurality of selected rules, among a plurality of rule selection patterns generated by selecting the single or the plurality of rules from among the plurality of rules.

11. An information processing apparatus comprising:
a memory; and
a processor coupled to the memory and configured to:
generate a plurality of rules that indicates an answer pattern to two or more questions included in a plurality of questions, based on questionnaire data that indicates answers of a plurality of respondents to each of the plurality of questions in a conducted questionnaire survey;
specify a respondent who has provided a correct answer that is same as an answer pattern to a question indicated in a rule, for each of the plurality of rules, based on the questionnaire data; and
determine a first rule selection pattern, based on the number of questions included in a single or a plurality of selected rules, from among rule selection patterns that satisfy a first constraint condition that each of the plurality of respondents is specified as the respondent who has provided the correct answer by any one of the single or the plurality of selected rules, among a plurality of rule selection patterns generated by selecting the single or the plurality of rules from among the plurality of rules.
